(19) United States
(12) Patent Application Publication
(10) Pub. No.: US 2014/0079014 A1
(43) Pub. Date: Mar. 20, 2014

(54) METHOD FOR MANAGING SELECTIVE ACCESS TO A WIRELESS NETWORK IN A MOBILE TERMINAL AND AN APPARATUS FOR SAME

(71) Applicant: AIRPLUG INC., Seoul (KR)

(72) Inventor: Seung Jun Lee, Seoul (KR)

(21) Appl. No.: 14/115,773

(22) PCT Filed: Jun. 1, 2012
(86) PCT No.: PCT/KR2012/004342

§ 371 Date: Nov. 5, 2013

(30) Foreign Application Priority Data
Jun. 3, 2011 (KR) 10-2011-0053712

(51) Int. Cl. H04W 74/08

(52) U.S. Cl. CPC H04W 74/0808
USPC 370/329

(57) ABSTRACT

The present invention relates to a method and apparatus for managing access to a wireless data network in a wireless communication terminal. In a wireless communication terminal embodying the invention, wireless signal from at least one of access points of a wireless data network is firstly detected and the strength of the signal is saved. Then, signal strength is secondly detected from the at least one of access points and differences between the firstly-detected signal strengths and the secondly-detected ones are calculated for each of the at least one of access points. Based on whether or not the differences fall within a predetermined range, it is determined whether a wireless communication terminal is in motion or not. If the terminal is in motion, accessing to a wireless data network is prohibited or a sign indicating that access to a wireless data network is impossible is displayed even though access points accessible are found. If the terminal is determined to be in abeyance, access to a wireless data network is attempted or a sign indicating that access is possible is displayed.

### TECHNICAL FIELD

This document relates to a method and apparatus for managing selective access to a wireless data network, e.g., a Wi-Fi network in a wireless communication terminal.

### BACKGROUND ART

As wireless data network technologies progresses, people can use a variety of wireless devices such as cellular phones, smartphones and tablet computers any time, any where.

In cases where people have to download/upload a large amount of data, for example, video clips or watch video stream, they tend to use a high-speed wireless data network, for example, Wi-Fi wireless network over cellular phone networks such as CDMA2000 or W-CDMA networks. It is because the Wi-Fi network enables a higher data rate and is usually free of charge. Therefore, when a Wi-Fi network accessible is found during the connection to a cellular phone network, users are usually notified and most of them seem not to hesitate to attempt to access to the Wi-Fi network.

Unfortunately, as Wi-Fi networks have limited spatial coverage range, users often suffer from frequent disconnections while in mobile. Hence, although a user in mobile tries to establish connection to the Wi-Fi network accessible while in connection to a cellular phone network, the connection is subject to disconnection of service because of his/her mobility. In this case, moreover, data communication that is required for connection to a Wi-Fi network and/or reconnection to the cellular phone network causes a substantial overhead for the two networks.

### DISCLOSURE

### Technical Problem

It is an object of the present invention to provide a method and apparatus that manages selective access to a wireless data network based on whether or not the connection to wireless data network will be maintained.

It is another object of the present invention to provide a method and apparatus that manages selective access to a wireless network to enable reduction of overhead in two heterogeneous wireless networks that would occurs due to accessing to the two heterogeneous wireless networks alternately.

It is still a further object of the present invention to provide a method and apparatus that determines whether a wireless communication terminal is in motion or not so as to make decision on whether or not connection to a wireless data network will be maintained in cases where location information from GPS signal is not available.

The scope of the present invention is not necessarily limited to the above explicit statements. Rather, the scope of the present invention covers anything to accomplish effects that could be derived from the below specific and illustrative explanations of the present invention.

### Technical Solution

A method of managing access to a wireless data network in a wireless communication terminal according to an aspect of the present invention, comprises: detecting wireless signals from one or more access points of the wireless data network N−1 (N>=2) times at different points of time, and for each of the access points, storing strengths of the detected wireless signals in a detected order thereof; detecting wireless signals from one or more access points of the wireless data network once more (N-th detection), and determining which state the wireless communication terminal is in among predetermined states including at least a first state and a second state, based on numerical values derived from differences between a strength of each of all or part of the N-th detected wireless signals and one of the stored strengths, said one of the stored strengths and the strength of said each of all or part of the N-th detected wireless signals being about signals detected from same access point; and conducting an operation selectively for switching connection state/disconnection state to the wireless data network, or for displaying accessibility to the wireless data network, according to the determined state.

In one embodiment of the present invention, the determining comprises checking identifiers of the access points to know whether wireless signals detected at each order are from same access point.

In embodiments of the present invention, the first state is a state designated for a numerical range of difference between signal strengths detected respectively at different points of time while a spatial distance or a signal propagation distance between a wireless communication terminal and an access point is changing, and the second state is a state designated for a numerical range of difference between signal strengths detected respectively at different points of time while spatial distance or signal propagation distance between a wireless communication terminal and an access point is changed a little or not changed.

In one embodiment of the present invention, the determining comprises determining that the wireless communication terminal is in the first state, based on: whether one of the numerical values exceeds a predetermined threshold; whether a sum of the numerical values exceeds a predetermined threshold; or whether an average of the numerical values exceeds a predetermined threshold.

In one embodiment of the present invention, if the wireless communication terminal is determined to be in the first state, the conducting an operation selectively comprises causing the wireless communication terminal being disconnected to the wireless data network not to be connected to the wireless data network, or controlling display state of the wireless communication terminal in order for a user to recognize that the wireless data network is inaccessible, even though wireless signals are detected from said one or more access points. In the present embodiment, in a case of causing the wireless communication terminal not to be connected to the wireless data network, the conducting an operation selectively may comprises activating a data transfer control layer for a cellular phone network having communication infrastructure separated from the wireless data network in order for subsequent data communication to be made over the activated data transfer control layer. In addition, if the wireless communication terminal is determined to be in the first state, the method may further comprise adjusting a period of time to detect wireless signals repeatedly or postponing detection of wireless signals until conditions for re-detection are satisfied, based on a direction of change in signal strengths that were stored from the N-times detections of wireless signals from said one or more access points.

In one embodiment of the present invention, if the wireless communication terminal is determined to be in the second state, the conducting an operation selectively comprises notifying that the wireless communication terminal being connected to the wireless data network may be disconnected.

In one embodiment of the present invention, when determining whether the wireless communication terminal is in the first state or in the second state, the determining comprises applying a threshold that is selected differently depending on whether the wireless communication terminal was determined to be in the first state or the second state at a preceding determination.

In one embodiment of the present invention, when determining whether the wireless communication terminal is in the first state or in the second state, the determining comprises applying a threshold that is selected differently depending on whether the wireless communication terminal is being connected to the wireless data network or not.

In one embodiment of the present invention, the determining comprises: selecting, for each of all or part of said one or more access points, a pair of signal strengths whose detected points of time are mutually different based on each of signal strengths detected at each detected point of time or based on differences between signal strengths that are detected at different points of time from same access point; and determining whether the wireless communication terminal is in the first state or the second state, based on numerical values derived from a difference between two strengths of each pair of the selected pairs of signal strengths. In the present embodiment, the selecting may comprise excluding a particular signal strength not to be selected wherein the particular signal strength is a strength smaller than a predetermined threshold, among the signal strengths stored from the N-times detections, a strength of wireless signal detected from an access point of which wireless signal changes more than a predetermined range, or a strength, among the signal strengths stored from the N-times detections, of wireless signals detected from an access point which shows different change direction in signal strength from most access points. In another manner, if particular signal strengths are, among the signal strengths stored from the N-times detections, relatively high compared with remaining signal strengths and change of the particular signal strengths is smaller than that of the remaining signal strengths, the selecting comprises excluding the remaining signal strengths not to be selected. In the present embodiment, the selected pair of signal strengths is composed of signal strengths that are consecutive or not consecutive in the detected order.

In one embodiment of the present invention, the numerical values may be either signal strength values representing the differences or ratios of the differences to signal strengths.

In one embodiment of the present invention, the detecting and storing is initiated in response to a message from a remote server indicative of requesting to report information on accessible resources of the wireless data network wherein the remote server is capable of communicating with the wireless communication terminal over a cellular phone network with communication infrastructure separated from the wireless data network.

In one embodiment of the present invention, the detecting and determining is initiated in response to a message from a remote server indicative of notifying permission of access to the wireless data network wherein the remote server is capable of communicating with the wireless communication terminal over a cellular phone network with communication infrastructure separated from the wireless data network, and wherein the message includes information specifying at least one belonging to a set of access points, which wireless signals are detected from at P-th (1<=P<N) order, of the wireless data network.

In another embodiment of the present invention, the detecting and storing, the detecting and determining, and the conducting are sequentially initiated by the wireless communication terminal without intervention of a remote server capable of communicating data over a network.

In one embodiment of the present invention, during the N-times detections of wireless signals, a part of channels at which effective signals were detected at a preceding detection are scanned in case of a particular scan mode, e.g., “quick mode”, or if a remote server capable of communicating over a network designates the part of channels to scan.

A wireless communication terminal capable of communicating with a wireless data network or a cellular phone network with communication infrastructure separated from the wireless data network according to another aspect of the present invention comprises: a communication unit configured to exchange data through transceiving signals according to a protocol adopted by the wireless data network, and to detect strength of wireless signals from one or more access points of the wireless data network; an I/O unit configured to receive an input from a user and to provide visual information for a user; and a controller configured: to control operations for exchanging information with an external device through the communication unit; to cause the communication unit to detect signal strengths N (N>=2) times at different points of time; to determine which state the wireless communication terminal is in among predetermined states including at least a first state and a second state, based on numerical values derived from differences between a strength of each of all or part of N-th detected wireless signals and one detected prior to the N-th detection, said one and the strength of said each of all or part of the N-th detected wireless signals being about signals detected from same access point; and to conduct an operation selectively for switching connection state/disconnection state to the wireless data network via the communication unit, or for displaying accessibility to the wireless data network onto the I/O unit, according to the determined state.

Another wireless communication terminal capable of communicating with a wireless data network or a cellular phone network with communication infrastructure separated from the wireless data network according to another aspect of the present invention may comprise a controller configured: to control operations to exchange information with an external device through the communication unit; to cause the communication unit to detect signal strengths N (N>=2) times at different points of time; to judge whether the wireless communication terminal is moving relatively with respect to at least one among said one or more access points, based on numerical values derived from differences between a strength of each of all or part of N-th detected wireless signals and one detected prior to the N-th detection, said one and the strength of said each of all or part of the N-th detected wireless signals being about signals detected from same access point; and to conduct an operation selectively for switching connection state/disconnection state to the wireless data network via the communication unit, or for displaying accessibility to the wireless data network onto the I/O unit, according to a result of the judgment.

In one embodiment of the present invention, the wireless communication terminal further comprises a cellular communication unit configured to communicate data through transceiving signals according to a protocol adopted by the cellular phone network, wherein the controller is further configured to conduct voice or data communication with external devices or another communication terminal through the cellular communication unit.

An apparatus equipped with a storage storing for programs according to another aspect of the present invention, comprises: communication means being capable of transceiving data through communication with an outside entity; and storing means storing an application to be run on a wireless communication terminal, the application being transmitted or received through the communication means, wherein the application includes a program structure to accomplish operations, in case of being run on the wireless communication terminal, that comprise: detecting wireless signals from one or more access points of the wireless data network N−1 (N>=2) times at different points of time, and for each of the access points, storing strengths of the detected wireless signals in a detected order thereof; detecting wireless signals from one or more access points of the wireless data network once more (N-th detection), and determining which state the wireless communication terminal is in among predetermined states including at least a first state and a second state, based on numerical values derived from differences between a strength of each of all or part of the N-th detected wireless signals and one of the stored strengths, said one of the stored strengths and the strength of said each of all or part of the N-th detected wireless signals being about signals detected from same access point; and conducting an operation selectively for switching connection state/disconnection state to the wireless data network, or for displaying accessibility to the wireless data network, according to the determined state.

### Advantageous Effects

The above-explained invention or at least one embodiment of the present invention, which will be described hereinafter in details with reference to accompanying figures, prevents wireless communication terminals in mobile from connecting to wireless data networks that otherwise causes useless overhead of cellular phone network. This helps reduce overload of cellular phone network caused by frequent connection and disconnection to the network and thereby increase utilization of resources of each network by putting them in network's original service.

### DESCRIPTION OF DRAWINGS

FIG. 1 is a diagram illustrating a configuration of a wireless communication terminal implementing the method of managing selective access to a wireless data network, according to the present invention.

FIG. 2 illustrates an example of the predefined notification icon 21 in a status bar on the display panel.

FIG. 3 is a flowchart illustrating a method of determining whether a wireless communication terminal is in motion or not based on change of the strength of signal from access points of a Wi-Fi network, according to an embodiment of the present invention.

FIG. 4 illustrates a wireless environment where wireless communication terminal communicate to nearby access points of a wireless network.

FIG. 5 and FIG. 6 illustrate signal strengths that were obtained from nearby access points in different points of time and saved, according to an embodiment of the present invention.

FIG. 7 is a flowchart illustrating a method of calculating differences between the current signal strengths and the signal strengths saved previously, according to an embodiment of the present invention.

FIG. 8 illustrates that the signal strengths are detected more than three times to determine if a wireless communication terminal is in motion, according to an embodiment of the present invention.

FIG. 9 illustrates that in addition to a pair of the consecutive signal strengths, a pair of the non-consecutive signal strengths are adopted to compute change of the signal strengths, according to an embodiment of the present invention.

FIG. 10 illustrates a network configuration where a method of managing selective access to a Wi-Fi network in a wireless communication terminal is implemented, according to an embodiment of the present invention.

### MODE FOR INVENTION

Hereinafter, embodiments of the present invention will be described in detail with reference to the accompanying drawings.

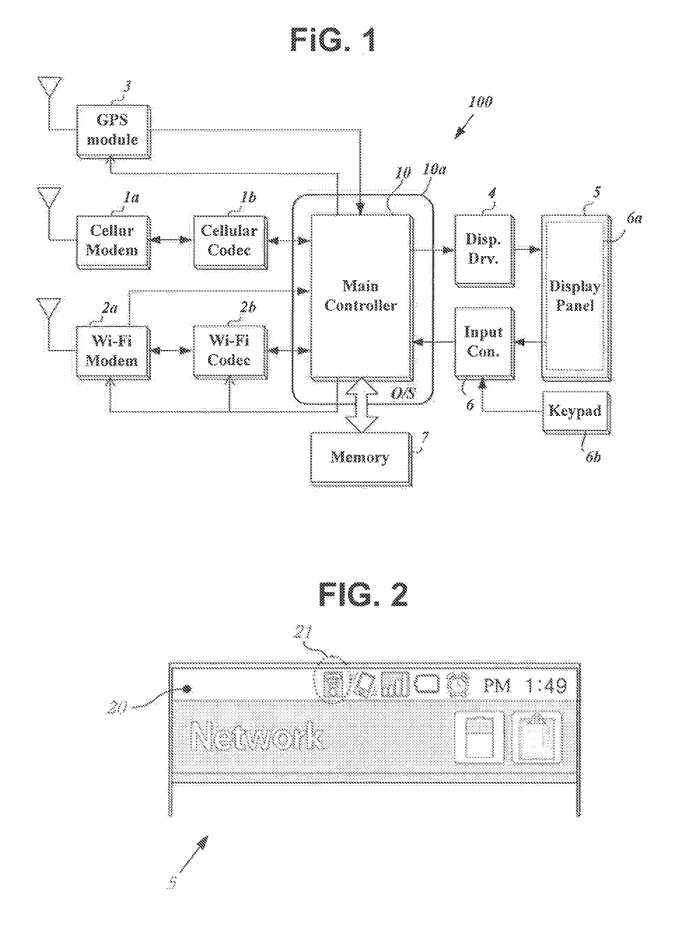

FIG. 1 is a diagram illustrating a configuration of a wireless communication terminal embodying the method for managing selective access to a wireless data network according to the present invention. The wireless communication terminal (hereinafter, wireless terminal) 100 is capable of accessing to both a cellular phone network and a high-speed wireless data network. The wireless terminal can be a smart phone, tablet computer, or notebook.

To be more specific, the wireless terminal 100 is comprised of a global positioning system (GPS) module 3 that calculates a current location information from GPS signal, a cellular modem 1a (including RF signal processing module) that modulates and demodulates signals in a predetermined manner to send/receive data over a cellular phone network such as 2G or 3G network, a cellular codec 1b that encodes and decodes data in accordance with a communication protocol of the cellular phone network, a Wi-Fi modem 2a (including RF signal processing module) that modulates and demodulates signals to send/receive data over a high-speed data network such as Wi-Fi network, codec 2b that encodes and decodes data in accordance with a communication protocol of the data network, a display panel 5 that displays text, image, or video, a display driver 4 that controls the panel to represent data on the panel visually, a touch sensor 6a being attached to the rear face of the panel, a keypad 6b consisting of keys and/or buttons, an input controller 6 that receives the input and/or selection that a user enters by the touch sensor and the keypad and that generates data associated with the input and/or selection, a main controller 10 that controls all of the components to perform specific operations, to make outputs in response to the input and/or selection by a user, and to display the outputs or an UI menu screen on the panel, and a memory 7 that offers a space required for the operation of the main controller.

In addition, an operating system (OS) 10a is installed in the wireless terminal 100 to support and perform operations of the main controller 10 or run of application programs (hereinafter, App) stored in the memory 7. To execute the operations that will be described in detail below, the OS 10a performs computer's fundamental operations of computer such as allocation of the physical resources of the components of FIG. 1 and management of exchanging signal and/or information between the components. In the detailed descriptions below, the operations of the main controller 10 or running of Apps on the wireless terminal 100 has the premise that the OS 10a works properly. Hence, OS's operations are skipped in the following descriptions.

The configuration shown in FIG. 1 is an exemplary configuration of the wireless terminal 100 for describing the present invention specifically and illustratively. In addition to the components of FIG. 1, the wireless terminal 100 may further comprises components capable of performing various functions, e.g., a particular App. Even so, as long as the basic concept or principle of the present invention that will be illustratively described hereinafter is implemented in a wireless terminal with or without an App, such a wireless terminal should be regarded as belonging to the scope of the present invention, unless it is explicitly excluded by the appended claims.

The main controller 10 determines whether or not a wireless data network such as Wi-Fi wireless network is accessible at the current location by selectively activating the Wi-Fi modem 2a and Wi-Fi codec 2b and if connection to a wireless data network has been established, performs data transmission and reception to/from the network. The Wi-Fi modem 2a senses a pilot channel signal in its activated state by demodulation in the designated RF bandwidth and notifies the main controller 10 if a pilot signal is detected. Upon detection of the pilot signal, the main controller 10 controls the display driver 4 to notify a user that an accessible Wi-Fi wireless network (hereinafter, Wi-Fi network) is found around him/her by displaying a notification symbol on the display panel 5. FIG. 2 illustrates an example of the predefined notification icon 21 in a status bar on the display panel.

If a user finds the predefined icon 21, he/she usually wants to use the Wi-Fi network because the network is much better than cellular phone networks in terms of the connection speed and cost (Wi-Fi networks are usually free of charge). For example, he/she can execute streaming Apps to play movie, TV drama, or music on the wireless terminal 100. However, as the coverage of a Wi-Fi network is commonly limited, he/she is often disconnected from the Wi-Fi network and is thus in out-of-service while he/she is in motion. For example, in a case where an access point (AP) of a Wi-Fi network is installed in subway train, he/she experiences disconnection from the Wi-Fi network when the train moves away from him/her. Such intermittent connection to a Wi-Fi network causes overhead with respect to network resources.

it should be noted that in the descriptions below, expressions of “being in motion”, “not being in motion”, “mobility”, “being receding”, and “being approaching” should be interpreted in terms of “relative movement” between a wireless terminal and an AP of Wi-Fi network, unless otherwise specified. The relative movement between them signifies the movement of either one or both that causes changes in terms of spatial distance or signal propagation distance.

In a preferred embodiment of the present invention, mobility (whether in motion or not) of a wireless terminal is determined even though a Wi-Fi network accessible is found. Practically, whether a wireless terminal is “in motion” or “not in motion” is determined by identifying which range change of the signal strength from APs of the Wi-Fi network or a rate of the change belongs to among ranges designated respectively for the two states of “being in motion” and “not being in motion”. The respective ranges are statistically estimated from data of the strength of signals from APs. If it is determined that the wireless terminal is in motion, displaying a symbol indicating that an accessible Wi-Fi network is found is prohibited or a symbol signifying that there is no Wi-Fi network accessible is displayed on the display panel.

In an open outdoor environment, the GPS module 3 makes it possible to determine whether or not the wireless terminal is in motion by examining if location information changes based on a GPS signal from satellites. However, the GPS module 3 is useless in an indoor environment where a GPS signal is not available. Also, as the GPS module 3 generally needs high power consumption, the main controller 10 generally makes the GPS module 3 maintain its inactive state if functions based on location information, e.g., Apps utilizing location information are not necessary. The inactive state represents a state where no power is supplied or a stand-by state if a module supports its stand-by mode, which holds in descriptions below.

Hence, while a Wi-Fi network is accessible, location information from the GPS module 3 may not be available in the step of determining whether or not the wireless terminal is in motion. In addition to the power consumption, use of the GPS module 3 needs to activate the GPS module 3 that has been in its inactive state due to power saving, which takes a some period of time for the GPS module 3 to be in its normal state where location data is supplied reliably.

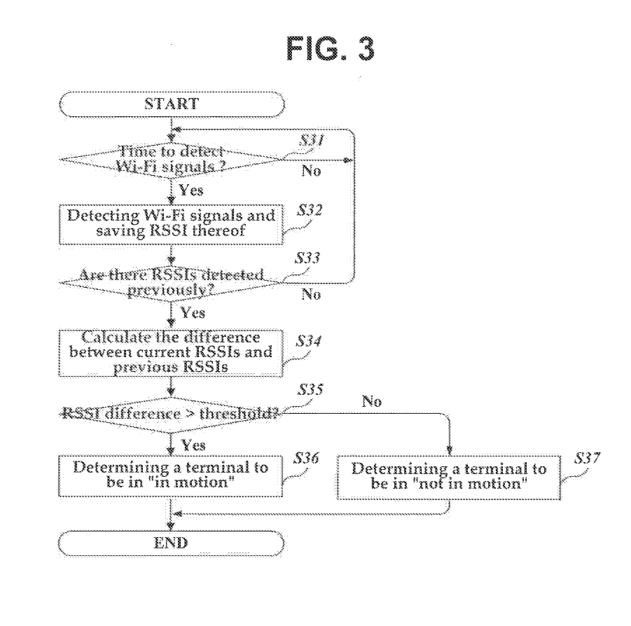

For this reason, in embodiments of the present invention a decision is made as to whether or not a wireless terminal is in motion on the basis of not location information from the GPS module 3 but changes of the strength of signals from APs of a Wi-Fi network. FIG. 3 is a flowchart illustrating a method of determining whether a wireless terminal is in motion or not based on change of the strength of signal from APs of a Wi-Fi network.

When the time comes when it is checked if signal from a Wi-Fi network is detectable (S31), the main controller 10 detects the strength of the signal from a Wi-Fi network and then stores the signal strength (S32). If the Wi-Fi modem 2a and the Wi-Fi codec 2b have been in their inactive states, they are activated to detect the signal strength. The time when it is checked if signal from a Wi-Fi network is detectable can vary depending on conditions. For example, the check can be made every a predetermined period of time. Also, by users request or selection, the operation of finding an accessible Wi-Fi network can be activated. The request or selection is made in a menu UI on the display panel 5 by either touch on a specific position on the touch sensor 6a or keystroke on the keypad 6b. As another example, the operation of checking if signal from network is detectable can be invoked remotely by request from a particular remote server in a network outside, for example, a cellular phone network to which data are communicated through the cellular modem 1a and the cellular codec 1b. The request may be made when the remote server requests the wireless terminal to send information of APs of a Wi-Fi network around the wireless terminal or when the server approves the wireless terminal's access to a Wi-Fi network.

In obtaining the signal strength from APs in a network, the Wi-Fi modem 2a offers a Received Signal Strength Indicator (RSSI) to the main controller 10. The RSSI value can be obtained only when effective signal is detected in the Wi-Fi signal bandwidth. Specifically, the Wi-Fi modem 2a casts a probing packet for each of 13 channels in the Wi-Fi signal bandwidth and, if there exist APs of the Wi-Fi network around the wireless terminal, receives response packets in response to the probing packets from the APs. The Wi-Fi modem 2a provides the main controller 10 with the RSSI value of each of the response packets, together with channel information and Service Set Identifier (SSID). The RSSI are obtained in a manner that the main controller 10 executes the read operation from a predetermined port of the Wi-Fi modem 2a or invokes a function in Application Programming Interface (API) provided by the OS 10a. Upon the RSSI values are received, the main controller 10 saves the RSSI values in a predetermined unit, e.g., dBm.

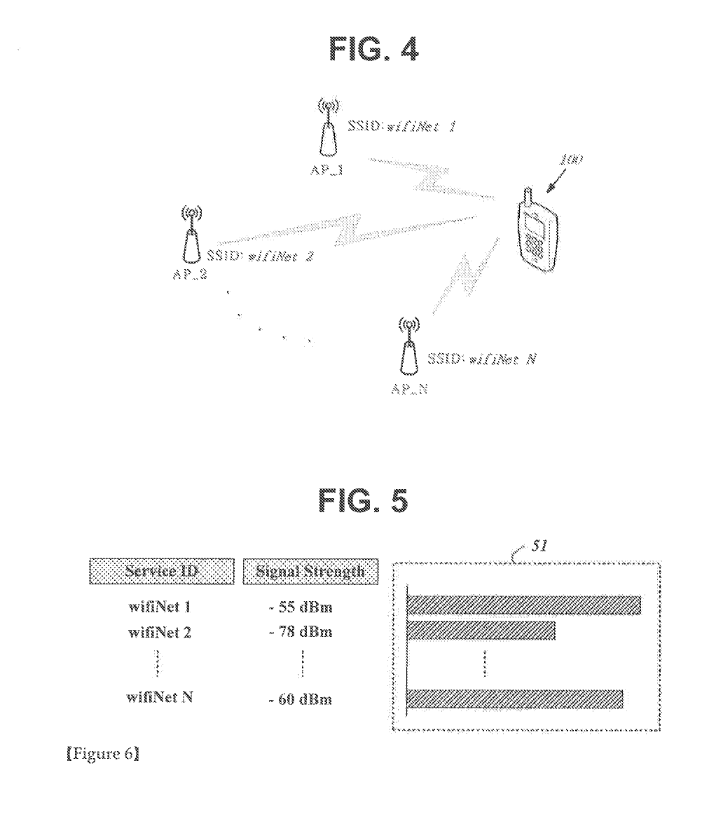

In a wireless environment as shown in FIG. 4, the main controller 10 stores N RSSI values in a specific format of FIG. 5. Graphic information 51 is just an illustration of representation of the RSSI values for the sake of convenient understanding, not the representation the main controller 10 really uses. Instead of SSID in FIG. 5, other identification information, e.g., Media Access Control (MAC) address may be used to identity APs. If no valid signal is detected in the step of obtaining the RSSI from each channel, no RSSI values are saved.

After the RSSI values of at least one of the channels are detected and then saved as described above, it is checked whether or not there exist the RSSI values that were saved previously (S33). If there is nothing, the main controller 10 waits until the next time. When the time comes again when it is checked if signal from a Wi-Fi network is detectable, the operation for detecting and saving the RSSIs is carried out (S32).

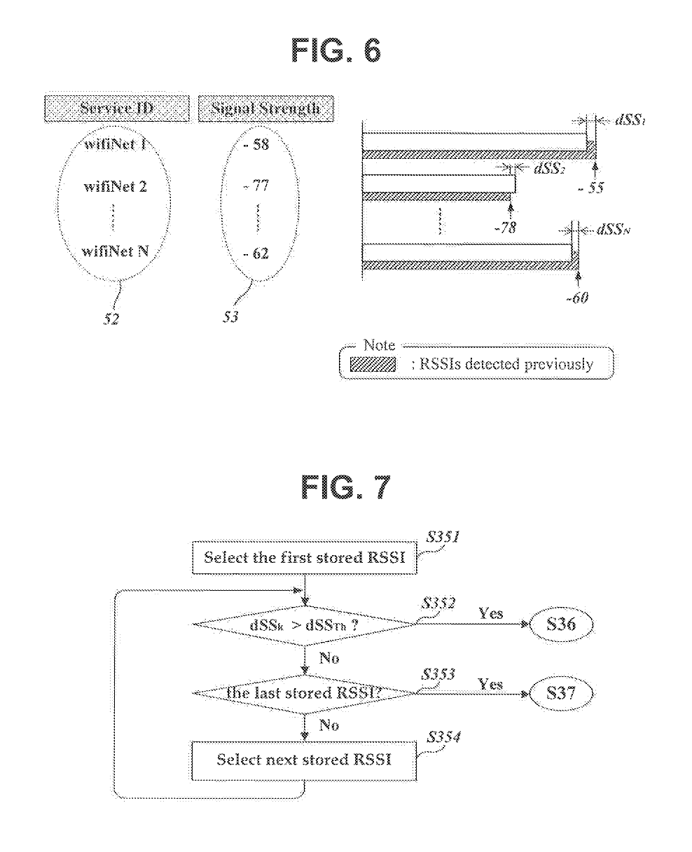

If it is determined that there is the RSSI value saved previously, the main controller 10 calculates the difference between the present RSSI value and the previous RSSI values (S34). Of course, it is checked on the basis of the AP identifier 52 whether or not the two RSSIs are from the identical AP. Then it is examined if the change of RSSI values exceeds a predetermined threshold (S35). The predetermined threshold can be set by several ways. For example, it is a difference in the unit of RSSI, 3 dBm or a rate of change, e.g., 3%. To be specific with reference to FIG. 6, for each AP, the difference between the present RSSI value and the previous one, dSSₖ is calculated first and it is then determined if at least one of the RSSI difference exceeds the predetermined threshold (S35).

FIG. 7 illustrates a flowchart of the detailed procedure. For each of the RSSI values stored as illustrated in FIG. 5, the main controller 10 checks if the RSSI difference, dSSₖ exceeds the predetermined threshold, dSS_{Th} (S351 to S354). If any RSSI difference exceeding the threshold is not found, the step of S35 terminates, and the main controller 10 determines that the wireless terminal is in the state of “not being in motion” (S37). Here, the state of “not being in motion” includes the case where the wireless terminal is in motion at a very slow speed. If found, the main controller 10 determines that the terminal is in the state of “in motion” (S36).

In another embodiment of the present invention, instead of using the RSSI difference it can be checked whether or not a value derived from the RSSI difference, e.g., a rate of change (dSSₖ/the previous RSSI value) exceeds a predetermined threshold, e.g., dSS_R_{Th} (%).

In another embodiment of the present invention, instead of using the RSSI differences individually as shown in FIG. 7, the RSSI differences are totally used in the step of determining if the wireless terminal is in motion. For example, the RSSI differences are summed and it is then checked whether or not the sum exceeds a predetermined threshold. Differently, an average (over the channels) of the RSSI differences or an average of rates of the RSSI difference may be adopted so that it is determined if the wireless terminal is in motion based on whether the average exceeds a predetermined threshold. Moreover, combination of the criterion elements stated earlier may be used in the step of determining and examining if the wireless terminal is in motion.

In another embodiment of the present invention, all of APs detectable are not considered. For AP only whose RSSIs meet a predetermined criterion, RSSI differences are calculated and used in the step of determining if the terminal is in motion or not. For example, AP whose RSSI values detected by the Wi-Fi modem 2a are greater than a predetermined threshold, e.g., −75 dBm is considered only and the RSSI difference is calculated. In FIG. 6, if the threshold is −75 dBm, AP whose SSID is “wifiNet 2” is excluded because its RSSI is −77 and thereby dSS₂ is not adopted.

In another embodiment of the present invention, all of the RSSIs are sorted in descending order and only for APs corresponding to the top-K, e.g., top 2 or 3, the RSSI differences are calculated and used in the step of determining if the terminal is in motion. For example, in FIG. 6, if K is 2, APs whose SSIDs are ‘wifiNet 1’ and ‘wifiNet N’ are considered and dSS₁ and dSS_{N} are used only.

In another embodiment of the present invention, for APs whose RSSI difference is abnormally large, whose direction of movement (will be described below) is different from those of others, the present RSSI value or all of the RSSI values so far can be excluded in calculating the RSSI differences and determining if the wireless terminal is in motion. Likewise, in cases where an AP is detected newly or APs discovered previously are not detected currently, the present RSSI value or all of the RSSI values associated with the AP may also be excluded because the RSSI difference cannot be computed.

The reason of exclusion of the RSSI values from the APs described above is as follows. If the RSSI difference for a single AP (or a minority of APs whose RSSI values are greater than a predetermined threshold) is greater than a predetermined maximum threshold or a single AP is detected and undetected alternately, there is high possibility that some obstacles, e.g., pedestrian or vehicle in motion cut in between the wireless terminal and the AP temporarily. It may also happen that an AP installed in a vehicle, e.g., subway train becomes far distant. Therefore, the exclusion of the APs helps to prevent some error in the decision-making as to whether the wireless terminal is in motion.

In a case where the RSSI difference of a single AP is large and the direction of relative movement is different from those of other APs, there is also very likely that the AP is in motion. Hence, the RSSI values of the AP are not used in the step of determining whether or not the wireless terminal is in motion.

In another embodiment of the present invention, if the RSSI value of a single AP is relatively strong and the RSSI difference is not large, and at the same time if the RSSI differences of the other APs are larger than that of the single AP, then the RSSIs of the others all are excluded and the single AP's RSSI is used only in the step of determining the state of the wireless terminal, leading to a decision that the wireless terminal is in the state of “not being in motion”. For example, the case described above may happen when a user of the wireless terminal is on board on a vehicle, e.g., subway train in which an AP is installed, and the vehicle starts to move. In this case, the wireless terminal is not in relative motion with respect to the AP inside vehicle while being in motion with respect to APs outside. In this embodiment of the present invention, if the RSSI value of a single AP is relatively strong and the RSSI difference is not large, and at the same time only if the RSSI differences of the other APs are larger than that of the single AP by a predetermined value, the RSSIs of the other APs may be all excluded in the step of determining if the wireless terminal is in motion.

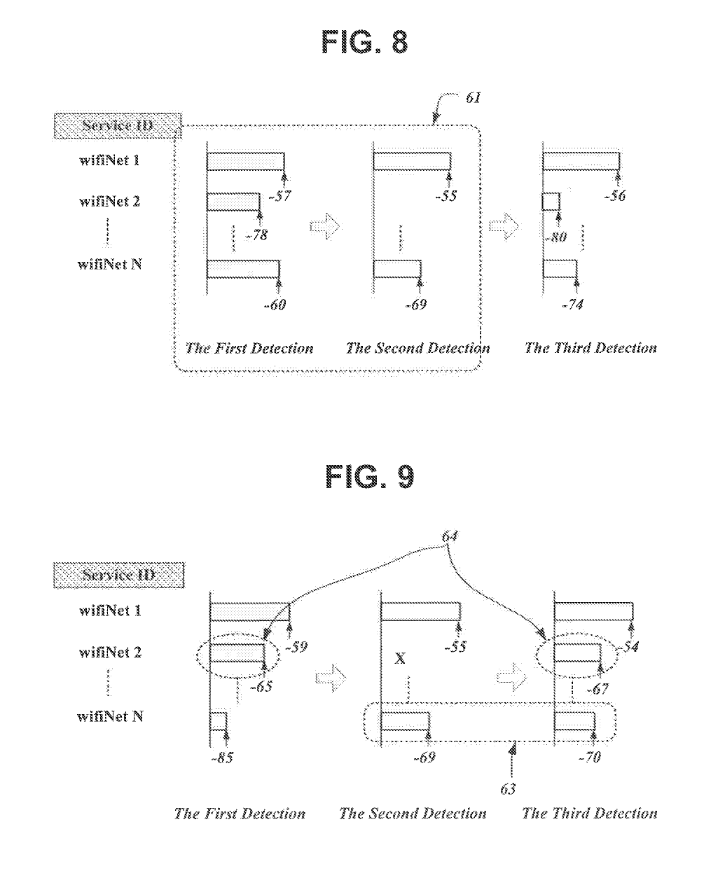

In the foregoing embodiments of the present invention, the decision as to whether or not the wireless terminal is in motion can be made based on the RSSI values that are obtained from more than three times of detection of RSSIs, not a single one. Use of the RSSI values obtained more than three times in different points of time not only helps to determine correctly if the wireless terminal is in motion but also enables to make the decision in the cases where the decision cannot be made from the RSSI values obtained once or twice. The procedure is described specifically with reference to an illustration of FIG. 8. Suppose that a RSSI value was obtained for each AP twice (the first and the second detection, 61 in FIG. 8) and that APs only whose RSSIs values are larger than a predetermined threshold (wifiNet 1 and wifiNet N in FIG. 8) are considered. For example, in a case where a RSSI difference (associated with wifiNet 1) is small (enough to determine if the wireless terminal is not in motion if considered only) and, at the same time where the other RSSI difference is large (enough to determine if the wireless terminal is in motion when considered only), if an absolute RSSI value of the AP whose RSSI difference is small is quite large compared with others, an decision on the relative movement of the wireless terminal is not made at the second detection but is postponed until another detection of RSSI values (the third detection in FIG. 8).

After the RSSI values are obtained once more al the third detection, the RSSI difference of the AP (wifiNet 1 in FIG. 8) whose RSSI difference was small but its RSSI value was relatively quite large is examined again to check if it is the same as the previous RSSI difference (at the second detection or both the first and second detection) or if change between them is, if any, negligible. If it is the same or negligible, an decision is finally made that the wireless terminal is not in motion even though the RSSI differences of other APs were not small. It should be noted that the decision-making described above with reference to FIG. 8 is just an illustration that explains how the RSSI values that were detected more than three times in different points of time can be used in the process of determining the relative motion of the wireless terminal, and that the method of using more than three consecutive RSSI values are applicable to other cases that are different from the above example.

In another embodiment of the present invention, in cases where more than three times of detection of the RSSIs are made, two consecutive or non-consecutive RSSI values can be used and, moreover more than three consecutive RSSI values can be used in some cases. FIG. 9 illustrates a case in which three consecutive RSSI values are not available for some APs. To be specific with FIG. 9, at the second detection, the RSSI value of an AP (wifiNet 1) is large, −55 dBm, enough that it exceeds a predetermined RSSI threshold while another AP (wifiNet 2) is undetected and the RSSI value of the other AP (wifiNet N) is −69 dBm enough to exceed the predetermined RSSI threshold (but is smaller than the predetermined RSSI threshold, e.g., −85 dBm at the first detection). In this case, another detection of RSSI values (the third detection in FIG. 9) is performed because RSSI values are insufficient to use. After that, a pair of RSSI values obtained at the second and third detections (63 in FIG. 9) or another pair of RSSI values obtained at the first and third detections (64 in FIG. 9) is used in the step of determining if the wireless terminal is in motion. If there are no RSSI values that exceed a predetermined RSSI threshold at the third detection, a pair of the RSSI values obtained at the first and second detections is used.

Of course, for an AP whose RSSIs value obtained at more than three times of detection all exceed the predetermined RSSI threshold (wifiNet 1 in FIG. 9), two consecutive RSSI values are chosen arbitrarily to obtain an RSSI difference. In some cases, the direction of relative movement of the wireless terminal can be estimated from changes between two consecutive RSSI values of an single AP and is then used in the decision on whether or not the wireless terminal is in motion. The direction of relative movement is defined as a direction indicator that represents whether the wireless terminal becomes closer (“approaching”) or farther (“receding”) to the single AP relatively in terms of spatial distance or wireless signal propagation path. To be specific with reference to FIG. 9, the RSSI differences of an AP (wifiNet 1) are +4 dBm (=−55-(−59)) and +1 dBm (=−54-(−55)), which implies that the wireless terminal approaches the AP relatively at the time of the second detection and that there is no the relative motion between them at the time of the third detection. With the RSSI values only at the first and third detections, the direction of relative movement can be regarded as being approaching the AP.

When it is determined that the wireless terminal is not in motion, the main controller 10 controls the display driver 4 to display an icon 21 notifying that a Wi-Fi network is accessible on the display panel 5, as shown in FIG. 2. If it is determined that the wireless terminal is in motion, no operation is performed to display the icon. 21 even if an accessible AP was found. Differently, an icon can be displayed that notifies that a Wi-Fi network is not accessible. Of course, the icon has a different symbol from the icon 21.

In another embodiment of the present invention, since the icon 21 has been displayed on the display panel 5 as it was determined that the wireless terminal was not in motion, the operation of determining if the wireless terminal is in motion can be carried out intermittently. At the time, if it is determined that the wireless terminal is in motion, the icon 21 disappears.

In the foregoing embodiments of the present invention, it is determined whether a wireless terminal is in motion or not in motion even though there is a Wi-Fi network to access. According to the relative movement of the wireless terminal, it is determined whether to display an icon notifying that a Wi-Fi network accessible is found. In another embodiment of the present invention which will be described in detail below, the decision on whether or not the wireless terminal is in motion is used in the step of determining whether to access to as Wi-Fi network.

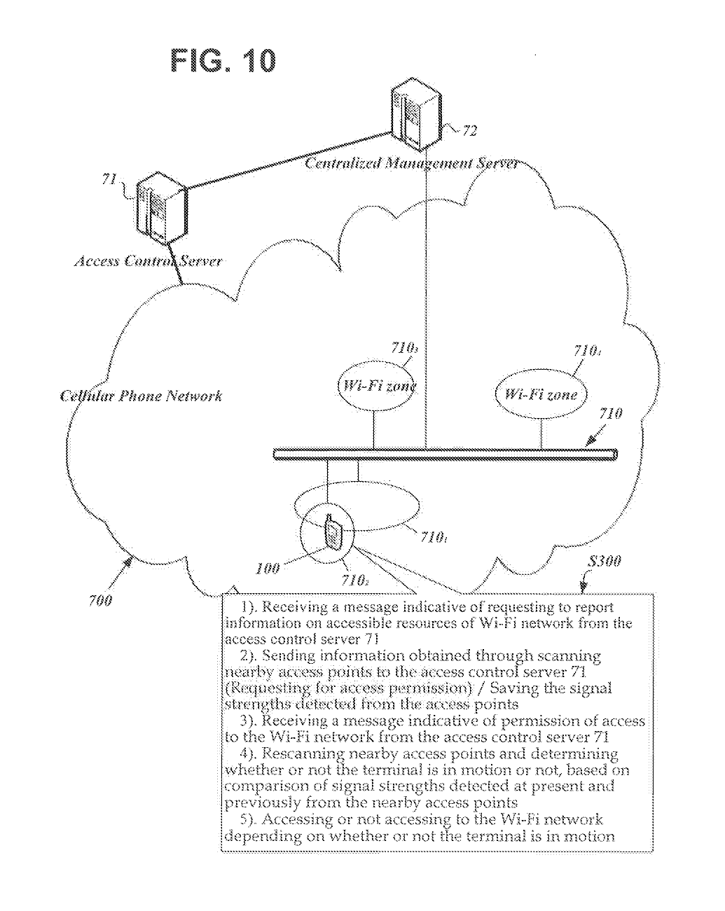

FIG. 10 illustrates a configuration of a network where a method of managing selective access to a Wi-Fi network in a wireless terminal is implemented according to an embodiment of the present invention. The network of FIG. 10 is composed of two heterogeneous networks based on different communication infrastructures, for example, a cellular phone network 700 and Wi-Fi networks 710,710₁, an access control server 71 that controls access to the networks 710,710₁, and a central management server 72 that manages network resources efficiently, in an integrative way by monitoring traffic in the cellular phone network 700 and Wi-Fi networks 710,710₁, and that manages in a centralized way information of wireless terminals accessing to the cellular phone network 700 and Wi-Fi networks 710,710₁.

In this embodiment, a wireless terminal 100 performs a series of operations (S300), each corresponding to the step of flowchart of FIG. 3. To be specific, the wireless terminal receives a request message from the access control server 71 indicative of requesting to send information of the network accessible at the wireless terminal. The request message is transmitted from the access control server 71 when particular conditions are met, for example, when the wireless terminal 100 receives content data from a particular server not shown) in stream mode or in download mode, or when the wireless terminal is in or close proximity to a Wi-Fi zone 710N that the access control server 71 have identified. The wireless terminal 100 can be localized by several localization methods.

Specifically, a message is received through a wireless channel of the cellular phone network 700, for example, a paging channel, and is demodulated and decoded by the cellular modem 1a and the cellular codec 1b, respectively and is then sent to the main controller 10. If it is determined that the decoded data is a request message indicative of requesting to send information of the Wi-Fi network accessible (S31 in FIG. 3), a scan is made for all or part of channels in the Wi-Fi frequency hands once or more than twice periodically. If at least one AP of a Wi-Fi network is found during the scan, general information of the APs including RSSI values is obtained and saved as illustrated in FIG. 5 (S32 in FIG. 3). Information of the APs including their IP addresses is packed into a report message of resource information on Wi-Fi network and is then sent to a nearby base station of the cellular phone network 700 through a channel of the cellular network 700, e.g., the access channel. Specifically, before the report message is sent, the message is encoded in a specific encoding scheme by the cellular codec 1b and is modulated by the cellular modem 1a. The report message contained in the access channel is interpreted to a predetermined way in an switch center of the base station. Upon the interpretation is complete, the report message is routed to the access control server 71 via a network dedicated to network control and management.

The scanning not all but part of channels in the Wi-Fi frequency bands is carried out when the access control server 71 designates which channel to scan or when the terminal has been in a particular scan mode, so-called fast mode, in which the scan is made only for channels that had effective signals at the previous scan.

In another embodiment of the present invention, reception of the request message and creation/sending of the report message in they wireless terminal 100 can be performed by execution of the codes in the firmware or hard coded program on an embedded processor or by running a particular App.

Once the report message is received, the access control server 71 designates a single AP (for example, an AP in Wi-Fi zone 710₂ in FIG. 10) by choosing a single IP address out of IP addresses included in the report message. Then the access control server 71 composes a connection admission message and sends it to the wireless terminal 100 so that the wireless terminal 100 can connect to the network (710 in FIG. 10) through the designated AP.

Specifically, the access control server 71 selects a single AP out of a plurality of APs which has been specified in the report message by referring to service attribute information that is already associated with the wireless terminal 100. The service attribute information provided by the central management server 62 includes traffic information or network load of each AP in the Wi-Fi zone. For example, the access control server 71 may choose one from a plurality of APs included in the report message of resource information on network, based information, provided by the central management server 62, on load of each AP and/or traffic of a local network to which each AP is connected.

In another embodiment of the present invention, the service attribute information associated with the wireless terminal can further includes registration information of the other wireless terminals which co-exist and are being serviced in the Wi-Fi zone to which the wireless terminal can access. That is, a single AP is chosen out of the APs based on registration information of the other wireless terminals. The registration information signifies information that is commonly collected when a user subscribes to the service of cellular phone network. The registration information also includes user class of service and the quality of service subscribed. The registration information is stored in a database in the central management server 62.

When the wireless terminal 100 attempts to access to network 710 in a Wi-Fi zone based on the connection admission message or regardless of reception of the connection admission message, the central management server 62 provides the access control server 71 with a registration information associated with the wireless terminal 100. Then, the access control server 71 refers to the registration information of the other wireless terminals in each Wi-Fi zone when determining which AP is assigned for permission of access of the wireless terminal 100. For example, when two APs (710₁ and 710₂ in FIG. 10) are specified in a report message of resource information sent from the wireless terminal 100 in response to a request message indicative of requesting to send information of Wi-Fi network accessible, if it is determined that other wireless terminals in one AP (710₁ in FIG. 10) have high user class of service or demand high quality of service, the other AP (710₂ in FIG. 10) is chosen for the wireless terminal 100, even though the traffic in the service area covered by the AP (710₁ in FIG. 10) is relatively low.

In addition to the information described in foregoing embodiments, the service attribute information to which the access control server 71 refers can include other information. Examples are traffic information of a service area of the cellular phone network 700 in which the wireless terminal 100 is positioned, load on resources of the service area, AP type (public or private), a time zone of the present time, and a spatial location that the wireless terminal 100 belongs to.

In another embodiment of the present invention, instead of choosing a single AP out of APs specified in the report message, the access control server 71 determines an order of access priority for the APs, makes a list of APs according to the order of access priority, and sends a connection admission message including the list of APs to the wireless terminal 100. The order of access priority is determined based on the service attribute information described above.

Upon reception of the connection admission message at the wireless terminal 100, the message is demodulated and decoded by the cellular modem 1a and the cellular codec 1b, respectively, and is then forwarded to the main controller 10. Then, the main controller 10 acknowledges that the time comes when it is checked if signal of a Wi-Fi network is available (S31 in FIG. 3), performs the operation of obtaining the RSSI values of all APs of the Wi-Fi network from the modem 2a, and saves the RSSI values (S32 in FIG. 3). After that, it is checked if there are the RSSI values that were obtained before the last report message is sent (S33 in FIG. 3) and, if exist, the RSSI differences between the present RSSI values and the prior RSSI values are calculated, as illustrated in FIG. 6 (S34 in FIG. 3). Next, according to the foregoing embodiments of the present invention, it is examined whether or not each of the RSSI differences, a sum of them, or an average of them exceeds a corresponding predetermined threshold (S35 in FIG. 3). An decision is finally made based on the result as to whether the wireless terminal 100 is in motion or not (S36 or S37 in FIG. 3).

If it is determined that the wireless terminal 100 is not in motion, the operation of accessing to a Wi-Fi network is carried. For example, the main controller 10 finds an AP that is the single AP specified in the connection admission message or selects an AP out of a list of the APs that was composed according to their orders of access priority with consideration of predetermined conditions. Then, the main controller 100 sends a connection request to the Wi-Fi network 710 by using the IP address of the chosen AP. In response to the request, the wireless terminal 100 receives information required for access to the Wi-Fi network 710 including an IP address and Domain Network System (DNS) and thus gets connected to the Wi-Fi network 710. Once the connection is established, a particular App executed by the main controller 10 can open session and communicate to a server in the Wi-Fi network 710 or the other network via the Wi-Fi network.

If it is determined that the wireless terminal 100 is in motion, the main controller 10 discards information of the APs that are specified in the connection admission message and does not execute any operation to access to the Wi-Fi network 710. No access request is made to an AP (Of course, IP address and DNS are not set). Therefore, even though the wireless terminal 100 can actually access to a Wi-Fi network, the wireless terminal 100 does not execute the access operation because it is in the state of “in motion”. In other words, the wireless terminal maintains its state of being disconnected.

In an embodiment of the present invention if it is determined that the wireless terminal 100 is in motion, a series of the operations of obtaining RSSI values from APs and deciding whether the wireless terminal 100 is in motion or not is performed repeatedly during a predetermined period of time or with no time limitation. Once it is determined during the period of time that the wireless terminal 100 is no longer in motion, a single AP is chosen from the APs in the connection admission message and a trial is then made to access to the Wi-Fi network 710 via the chosen AP. Thanks to the repetition, a frequency that the report message is sent and the connection admission message is received in response can be reduced actually. The period of time that whether or not the wireless terminal 100 is in motion is examined depends on communication conditions in which the wireless terminal 100 is situated. For example, in a case where data is transmitted or received through the cellular modem 1a and the cellular codec 1b a higher rate than that of voice, the main controller 10 decreases the period of time to check if the wireless terminal 100 is in motion so as to make the wireless terminal 100 be connected to a Wi-Fi network earlier than otherwise when the case happens.

In another embodiment of the present invention, in addition to the RSSI differences, the magnitude of the RSSI differences or the direction of relative movement that was described in the foregoing embodiment can be used to perform adaptively the operation of determining if the wireless terminal is in motion. For example, in the case where RSSI values should be obtained for APs repeatedly because the wireless terminal was “in notion”, the period of time that the RSSI values are detected and the decision is made based on the RSSI differences can be shortened if it is determined that the wireless terminal is “approaching” a particular AP, its state still being “in motion”. Conversely, if it is determined that the wireless terminal is “receding”, its state still being “in motion”, the operation of determining whether or not the wireless terminal is in motion may be postponed until a request is made from a remote server or from inside, e.g., invoking a particular App.

In another embodiment of the present invention, in cases where an access to a Wi-Fi network was made because it was determined that the wireless terminal was “not in motion”, the operations of obtaining RSSI values from APs more than twice and deciding whether or not the wireless terminal is in motion based on the RSSI values can be carried out. For example, while the wireless terminal has been connected to a Wi-Fi network, it may be better to check if the terminal's state is changed into “in motion” or “receding” by executing the operations periodically. If so the main controller 10 notifies a user that his/her wireless terminal moves away from an AP or the connection may be lost shortly by using an alarm, e.g., buzzer or displaying a predetermined icon. Differently the main controller 10 can keep the data connection that otherwise would be lost by establishing connection to a cellular phone network 700. In other ways, searching for another AP in the Wi-Fi network as a substitute for the AP being connected can performed and be then notified to a user if a new accessible AP is found. Or if content data is being received from a remote server at the time when it is determined that the wireless terminal is in motion, the main controller 10 can execute an operation to make the content data remained be stored in a specified remote server.

In another embodiment of the present invention, when a decision as to whether or not the wireless terminal is in motion is made based on the RSSI differences, a decision threshold can be determined adaptively depending on the preceding decision on movement of the wireless terminal (“in motion” or “not in motion”). For example, when it was determined at the preceding decision that the wireless terminal was “not in motion”, a decision threshold by which it is again determined that the wireless terminal is “not in motion” is set differently from the threshold by it is determined that the wireless terminal is “not in motion” when it was determined that the wireless terminal was “in motion” at the preceding decision or when there are no preceding decisions. The decision threshold at the former case may be stricter that of the latter case.

In another embodiment of the present invention, when a decision as to whether or not the wireless terminal is in motion is made based on the RSSI differences, a decision threshold can be determined adaptively depending on whether connection to a Wi-Fi network is established or not (“connected” or “disconnected”). For example, a threshold by which it is determined that the wireless terminal is “not in motion” while being disconnected is set differently from a threshold by it is determined that the wireless terminal is “not in motion” while being connected. In one embodiment of the present invention the former threshold may be stricter that the latter. Taking a less strict threshold in the latter case helps to reduce the possibility that owing to user's minor, short movement, it is determined that the wireless terminal is in motion and thereby the connected state is changed to disconnected.

In the foregoing embodiments above, the decision threshold can be determined differently according to combinations of whether the wireless terminal was “in motion” or “not in motion” at the preceding decision-making and whether the wireless terminal has been “connected” or “disconnected” to a Wi-Fi network.

In another embodiment of the present invention, regardless of receiving the request message indicative of requesting to send the report message about Wi-Fi network resources around, the wireless terminal 100 scans, by itself, APs of Wi-Fi networks around, obtains and saves the RSSI values from the APs and sends an connection admission request message to the access control server 71. The operation of saving the RSSI values and sending the request message and the subsequent operations are carried out by run of some Apps in the memory 7 such as audio/video streaming Apps receiving a large amount of data from a remote server or pre-registered Apps or by execution of built-in firmware or middleware that is invoked by the main controller 10 when it is notified that the Apps are activated to run. After a connection admission message is received from the access control server 71, an AP to attempt to connect is selected out of the APs in the connection admission message. Before accessing a Wi-Fi network 710 via the chosen AP, according to the detailed descriptions above, the RSSI values are obtained from the APs by scanning around and it is then determined based on change of the RSSI values whether or not the wireless terminal is in motion. If the wireless terminal is in motion, accessing to the Wi-Fi network 710 is not attempted. The App in accordance with the embodiment of the present invention can be saved in the memory 7 after it has been downloaded from a remote server through the cellular phone network 700 or the Wi-Fi network 710 in response to wireless terminal's request.

In another embodiment of the present invention, if it is determined that the wireless terminal is in emotion, the main controller 10 can build a Transfer Control/Internet Protocol (TCP/IP) layer over channels of the cellular phone network 700 so that the wireless terminal 100 continues to exchange data with a remote server.

All or a part of the descriptions on the foregoing embodiments of the present invention can be applied to wireless terminals that support connection to Wi-Fi networks only, if such application to those wireless terminals is allowable. For example, embodiments of the present invention include wireless terminals with neither the cellular modem 1a nor the cellular codec 1b in FIG. 1. In this embodiment, immediately before a particular App runs, either the App itself or the main controller 10 performs a series of the operations of Obtaining the RSSI values from APs around more than once, calculating the RSSI differences and their changes, determining independently whether the wireless terminal is in motion or not based on the changes, and if possible, making connection to a Wi-Fi network or notifying a user that a Wi-Fi network is accessible.

In the foregoing embodiments of the present invention, whether a wireless terminal is in motion or not with respect to APs is determined based on changes of the signal strength between the wireless terminal and each AP, and according to the decision of relative movement of the wireless terminal, an access to a Wi-Fi network is attempted or a user is notified. On the other hand, in implementing the basic concept and principle of the present invention, without explicit, distinct exposure about the relative movement of a wireless terminal with respect to APs, the state of the wireless terminal may be directly identified to one of some states that are pre-classified from changes of a signal strength and then whether to connect to a Wi-Fi network is determined based on the identified state of the wireless terminal. In those implementations, however, if the fundamental motivation of their functions of determining whether to access to a Wi-Fi network lies in the fact that the wireless terminal moves away or close to the Wi-Fi network and if they have the premise that the relative movement of the wireless terminal can be estimated from changes of the signal strengths, it should be acknowledged that in those implementations, such operations of determining changes of the signal strengths and identifying the wireless terminal's state contains implicitly the operations of determining whether or not the wireless terminal is motion according to the present invention. Therefore, it is natural that those implementations are considered to fall within the basic concept and principle of this invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method of managing access to a wireless network in a wireless terminal, comprising:
detecting wireless signals from one or more access points of the wireless network N−1 (N>=2) times at different points of time under a disconnected state in which an IP address is not assigned from the wireless network, and for each of the access points, storing strengths of the detected wireless signals in a detected order thereof;
detecting wireless signals from one or more access points of the wireless network once more (N-th detection), and determining which state the wireless terminal is in among predetermined states including at least a first state and a second state, based on numerical values derived from differences between a strength of each of all or part of the N-th detected wireless signals and one of the stored strengths, said one of the stored strengths and the strength of said each of all or part of the N-th detected wireless signals being about signals detected from same access point; and
conducting an operation selectively for connecting to the wireless data network or for displaying accessibility to the wireless network, according to the determined state.

2-19. (canceled)

20. A wireless terminal capable of communicating with a first wireless network or a second wireless network with communication infrastructure separated from the first wireless network, the wireless terminal comprising:
a communication unit configured to exchange data through transceiving signals according to a protocol adopted by the first wireless network, and to detect strength of wireless signals from one or more access points of the first wireless network;
an I/O unit configured to receive an input from a user and to provide visual information for a user; and
a controller configured:
to control operations for exchanging information with an external device through the communication unit;
to cause the communication unit to detect signal strengths N (N>=2) times at different points of time under a disconnected state in which an IP address is not assigned to the communication unit from the first wireless network;
to determine which state the wireless terminal is in among predetermined states including at least a first state and a second state, based on numerical values derived from differences between a strength of each of all or part of N-th detected wireless signals and one detected prior to the N-th detection, said one and the strength of said each of all or part of the N-th detected wireless signals being about signals detected from same access point; and
to conduct an operation selectively for connecting to the first wireless network via the communication unit or for displaying accessibility to the first wireless network onto the I/O unit, according to the determined state.

21. (canceled)

22. The wireless terminal of claim 20, wherein the first state is a state designated for a numerical range of difference between signal strengths detected respectively at different points of time while a spatial distance or a signal propagation distance between a wireless terminal and an access point is changing, and the second state is a state designated for a numerical range of difference between signal strengths detected respectively at different points of time while spatial distance or signal propagation distance between a wireless terminal and an access point is changed a little or not changed.

23. The wireless terminal of claim 22, wherein the controller is configured to determine that the wireless terminal is in the first state based on:
whether one of the numerical values exceeds a predetermined threshold;
whether a sum of the numerical values exceeds a predetermined threshold; or
whether an average of the numerical values exceeds a predetermined threshold.

24. The wireless terminal of claim 22, wherein in case of determining that the wireless terminal is in the first state, the controller is configured to cause the wireless terminal being disconnected to the first wireless network not to be connected to the first wireless network, or control display state of the I/O unit in order for a user to recognize that the first wireless network is inaccessible, even though wireless signals are detected by the communication unit from said one or more access points.

25. (canceled)

26. The wireless terminal of claim 24, wherein in case of determining that the wireless terminal is in the first state, the controller is configured to adjust a period of time to detect wireless signals repeatedly or postpone detection of wireless signals until conditions for re-detection are satisfied, based on a direction of change in signal strengths that were stored from the N-times detections of wireless signals from said one or more access points.

27. The wireless terminal of claim 22, wherein in case of determining that the wireless terminal is in the second state, the controller is configured to notify that the wireless terminal being connected to the first wireless network may be disconnected.

28. The wireless terminal of claim 22, wherein when determining whether the wireless terminal is in the first state or in the second state, the controller is configured to apply a threshold that is selected differently depending on whether the wireless terminal was determined to be in the first state or the second state at a preceding determination.

29. The wireless communication terminal of claim 22, wherein when determining whether the wireless terminal is in the first state or in the second state, the controller is configured to apply a threshold that is selected differently depending on whether the wireless terminal is being connected to the first wireless network or not.

30. The wireless terminal of claim 20, wherein the controller is configured:
to select, for each of all or part of said one or more access points, a pair of signal strengths whose detected points of time are mutually different, based on each of signal strengths detected at each detected point of time or based on differences between signal strengths that are detected at different points of time from same access point; and
to determine whether the wireless terminal is in the first state or the second state, based on numerical values derived from a difference between two strengths of each pair of the selected pairs of signal strengths.

31. The wireless terminal of claim 30, wherein the controller is configured to exclude a particular signal strength not to be selected, the particular signal strength being a strength smaller than a predetermined threshold, among the signal strengths stored from the N-times detections, a strength of wireless signal detected from an access point of which wireless signal changes more than a predetermined range, or a strength, among the signal strengths stored from the N-times detections, of wireless signals detected from an access point which shows different change direction in signal strength from most access points.

32. The wireless terminal of claim 30, wherein if particular signal strengths are, among the signal strengths stored from the N-times detections, relatively high compared with remaining signal strengths and change of the particular signal strengths is smaller than that of the remaining signal strengths, the controller is configured to exclude the remaining signal strengths not to be selected.

33. The wireless terminal of claim 30, wherein the selected pair of signal strengths is composed of signal strengths that are consecutive or not consecutive in the detected order.

34. The wireless terminal of claim 20, wherein the numerical values are either signal strength values representing the differences or ratios of the differences to signal strengths.

35. The wireless terminal of claim 20, further comprising another communication unit configured to communicate data through transceiving signals according to a protocol adopted by the second wireless network,
wherein the controller is further configured to conduct voice or data communication with external devices or another wireless terminal through the another communication unit.

36. The wireless terminal of claim 35, wherein the controller is configured to initiate first signal strength detection of the N-times detections in response to a message, received by the another communication unit from a remote server connected to the second wireless network, indicative of requesting to report information on accessible resources of the first wireless network.

37. The wireless terminal of claim 35, wherein the controller is configured to initiate last signal strength detection of the N-times detections and to determine in which state the wireless terminal is, in response to a permission notifying message, received by the another communication unit from a remote server connected to the second wireless network, indicative of notifying permission of access to the first wireless network,
wherein the permission notifying message includes information specifying at least one belonging to a set of access points of the first wireless network, the set of access points being ones from which wireless signals are detected at P-th (1<=P<N) detection.

38. (canceled)

39. The wireless terminal of claim 20, wherein during the N-times detections of wireless signals, the controller is configured to scan a part of channels at which effective signals were detected at a preceding detection, in case of a particular scan mode or if a remote server designates the part of channels to scan, the remote server being capable of communicating with the wireless terminal through another communication unit configured to communicate data through transceiving signals according to a protocol adopted by the second wireless network.

40. A wireless terminal capable of communicating with a first wireless network or a second wireless network with communication infrastructure separated from the first wireless network, the wireless terminal comprising:
a communication unit configured to exchange data through transceiving signals according to a protocol adopted by the first wireless network, and to detect strength of wireless signals from one or more access points of the first wireless network;
an I/O unit configured to receive an input from a user and to provide visual information for a user; and
a controller configured:
to control operations to exchange information with an external device through the communication unit;
to cause the communication unit to detect signal strengths N (N>=2) times at different points of time under a disconnected state in which an IP address is not assigned to the communication unit from the first wireless network;
to judge whether the wireless terminal is moving relatively with respect to at least one among said one or more access points, based on numerical values derived from differences between a strength of each of all or part of N-th detected wireless signals and one detected prior to the N-th detection, said one and the strength of said each of all or part of the N-th detected wireless signals being about signals detected from same access point; and
to conduct an operation selectively for connecting to the first wireless network via the communication unit, or for displaying accessibility to the first wireless network onto the I/O unit, according to a result of the judgment.

41. An apparatus equipped with a storage storing for programs, comprising:
communication means being capable of transceiving data through communication with an outside entity; and
storing means storing an application to be run on a wireless terminal, the application being transmitted or received through the communication means,
wherein the application includes a program structure to accomplish operations, in case of being run on the wireless terminal, that comprise:
detecting wireless signals from one or more access points of a wireless network N−1 (N>=2) times at different points of time under a disconnected state in which an IP address is not assigned from the wireless network, and for each of the access points, storing strengths of the detected wireless signals in a detected order thereof;
detecting wireless signals from one or more access points of the wireless network once more (N-th detection), and determining which state the wireless terminal is in among predetermined states including at least a first state and a second state, based on numerical values derived from differences between a strength of each of all or part of the N-th detected wireless signals and one of the stored strengths, said one of the stored strengths and the strength of said each of all or part of the N-th detected wireless signals being about signals detected from same access point; and
conducting an operation selectively for connecting to the wireless network or for displaying accessibility to the wireless network, according to the determined state.

42. (canceled)
